(19) United States
(12) Patent Application Publication
(10) Pub. No.: US 2002/0092910 A1
(43) Pub. Date: Jul. 18, 2002

(54) Method and apparatus for detecting defective markings on a semiconductor product

(75) Inventors: Sung-Muk Lim, Chungcheongnam-do (KR); Joong-Kil Kook, Chungcheongnam-do (KR); Hyo-Geun Chae, Chungcheongnam-do (KR); Jeong-Ho Bang, Chungcheongnam-do (KR)

Correspondence Address: MARGER JOHNSON & McCOLLOM, P.C., 1030 S.W. Morrison Street, Portland, OR, 97205, US

(73) Assignee: Samsung Electronics Co., Ltd., Suwon-city (KR)

(21) Appl. No.: 10/027,639

(22) Filed: Dec. 19, 2001

(30) Foreign Application Priority Data
Jan. 17, 2001 (KR) 2001-2569

(51) Int. Cl. G06K 7/10; G06K 15/00

(52) U.S. Cl. 235/462.13

(57) ABSTRACT

A method and apparatus for detecting defective semiconductor product markings is provided. In one embodiment, a reference character set is inputted and stored. Actual character markings are recognized as an actual character set using an Optical Character Recognition (OCR) technique. The actual character set is compared to the stored reference character set to determine if the product is properly marked. If the character sets match, the marking is proper, otherwise, it is defective. Also, if the actual character markings cannot be identified as characters using the OCR technique, the product marking can be immediately classified as defective without comparison to the reference character set. Many other embodiments are also provided.

This application claims priority from Korean Patent Application No. 2001-2569, filed Jan. 17, 2001, the contents of which are incorporated herein by reference in their entirety.

### BACKGROUND OF THE INVENTION

1. Field of the Invention

The present invention relates to semiconductor chip assembly technology and, more particularly, to techniques for detecting defective marking on a semiconductor product.

2. Description of the Related Art

As is well known in the art, integrated circuit semiconductor chips are assembled into a package, and the packaged products are provided to users. The semiconductor products are marked with indicia such as alphanumeric characters, graphic images, or barcodes, that identify the type, the memory capacity, the operational speed, the manufacturer, the manufacturing date, and other information regarding the chip. These markings permit the user to easily determine the characteristics, usage, and purpose of the product. An ink marking method has been used in the past, but more recently, a laser marking method has become popular.

During chip production, after testing external terminals, such as outer leads, to evaluate operation of an assembled semiconductor product, the product is subjected to a visual test to detect defective marking. There are various types of defective marking, such as non-marking and cut-marking. In addition, even though the marking process may have been performed correctly, subsequent processes may result in different types of products being mixed together in a product lot. If undetected, improper mixing of products can cause fatal failures.

Accordingly, before providing the semiconductor products to users, the products are retested using a marking test to both detect defectively marked products in a lot and the presence of different product types in a lot. In the marking test, because manual visual inspection by workers of each and every product cannot be accommodated in a mass production process, selection testing utilizing cameras has been recently employed.

FIG. 1 illustrates conventional markings on a semiconductor product. FIG. 2 is a flow chart illustrating a conventional method for detecting defective markings on semiconductor products. As represented by FIG. 1, characters (including letters, numbers, and symbols) representing product information are printed on a surface of semiconductor products. Before detecting defective markings, criteria for distinguishing between good and defective products are prepared.

Referring to FIG. 2, after using a camera to take a picture image of a sample (step 11), image characteristics (or features) from each character region are extracted (step 12). The extracted image features are then stored (step 13) and used as a reference pattern for distinguishing between good and defective products. As each product in a lot is tested, the image of the product being tested is photographed (step 14). Image characteristics from each character region of the product marking are extracted (step 15) to create extracted image data (step 16) for the test product. The extracted image data is then compared with the reference pattern of the sample (step 17) to determine whether the marking is good or defective (step 18).

In accordance with this conventional testing method, since image features, such as shape or darkness, of the characters on the product to be tested are simply compared to the stored reference pattern, the results may not be exact. For example, differences in brightness or position of characters printed on the products in the same lot may adversely affect the test results. Also, dust or other contaminants on the product surface may produce erroneous test results. The conventional method may also have trouble discriminating between similar characters, such as between the numeric characters six (“6”) and eight (“8”), or between the alphabetic character “0” and a numeric character zero (“0”). When characters cannot be accurately distinguished from each other, it is difficult to discriminate between different types of products combined in a lot. Fatal product failures can therefore result.

### SUMMARY OF THE INVENTION

An object of the present invention is to provide a method for detecting defective markings on semiconductor products wherein marking characters are read and recognized as characters rather than images, to thereby increase the accuracy and reliability of the detecting method and to improve the defective marking detection rate.

According to a preferred embodiment of the invention, a method of detecting defective markings uses an Optical Character Recognition (OCR) technique to compare a character row (or set) read from a semiconductor product with a reference character set. The method preferably begins by inputting a reference character set into the test system. The reference character set corresponds to proper character markings on the semiconductor product to be tested. The reference character set is stored in a storage unit for later comparison with the actual character markings.

The markings of the product to be tested are then read by a readout system and image features of characters are extracted. The image features are then used to recognize each of the characters from the product marking using an OCR unit. This is accomplished, for instance, by comparing the extracted features with a set of character templates in an OCR database. The characters recognized by the OCR unit provide character row data. The character row data is compared to the stored reference character set to distinguish between good and defective product markings. An arithmetic unit can be used to perform this comparison.

A wafer can be divided into a plurality of semiconductor chips following an electrical characteristic test. The tested semiconductor products are preferably chip packages that contain one of these chips. The input unit can be a keyboard for directly inputting the reference character set, a bar code scanner for reading a bar code that has information regarding the reference character set embedded therein, or some other input device. The reference character set or bar code can be imprinted on a lot card. The readout system can be a Charge-Coupled Device (CCD) camera, a scanner, or other type of image detection device.

The method of detecting defective markings according to various aspects and embodiments of the present invention can be applied during a visual testing step following the assembly process. The method can also be applied during a final testing and packaging step just before providing the products to the users.

### BRIEF DESCRIPTION OF THE DRAWINGS

The foregoing and other objects, features, and advantages of the present invention will be more readily understood through the following detailed description of preferred embodiments thereof, which proceeds with reference to the accompanying drawings, wherein like reference numerals designate like structural elements, and, wherein:

FIG. 1 illustrates conventional markings printed on a semiconductor product;

FIG. 2 is a flow chart illustrating a conventional method of detecting defective markings on semiconductor products;

FIG. 3 is a flow chart illustrating a method of detecting defective markings on semiconductor products in accordance with a preferred embodiment of the present invention;

FIG. 4 is a plan view of a lot card which can be used in the method of detecting defective markings on semiconductor products, as shown in FIG. 3;

FIG. 5A is a flow chart illustrating a method of detecting defective markings on semiconductor products in accordance with another embodiment of the present invention;

FIG. 5B is a schematic block diagram illustrating a visual testing apparatus configured to perform the method of FIG. 5A;

FIG. 6A is a flow chart illustrating a method of detecting defective markings on semiconductor products in accordance with yet another embodiment of the present invention; and

FIG. 6B is a schematic block diagram illustrating a final testing and packaging apparatus configured to perform the method of FIG. 6A.

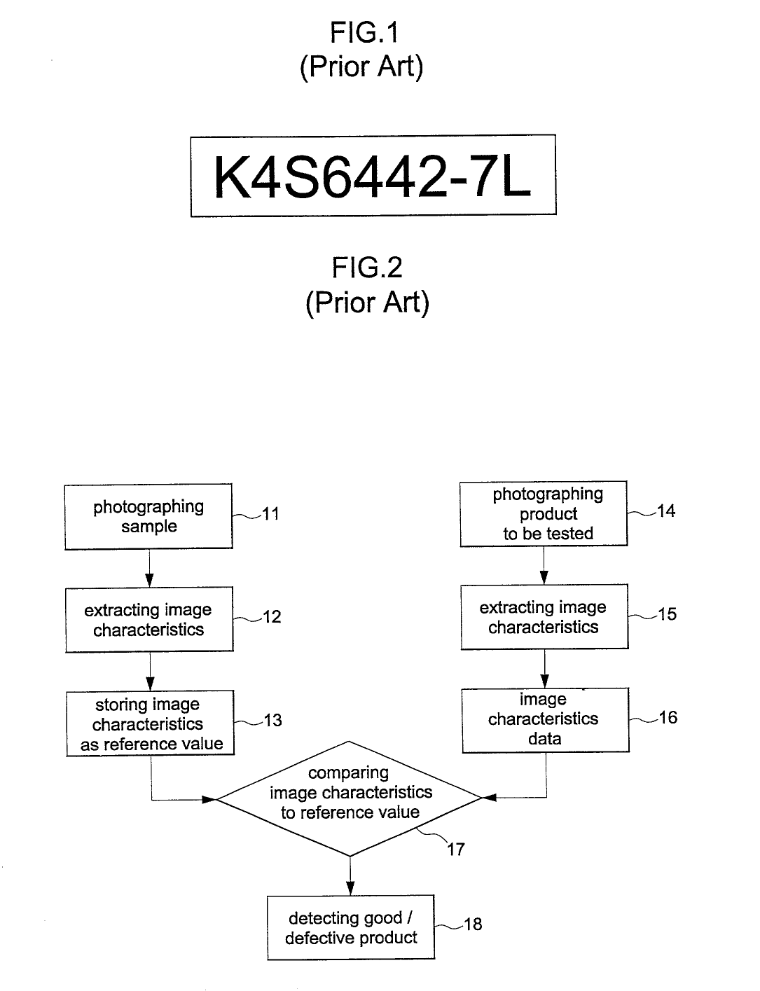

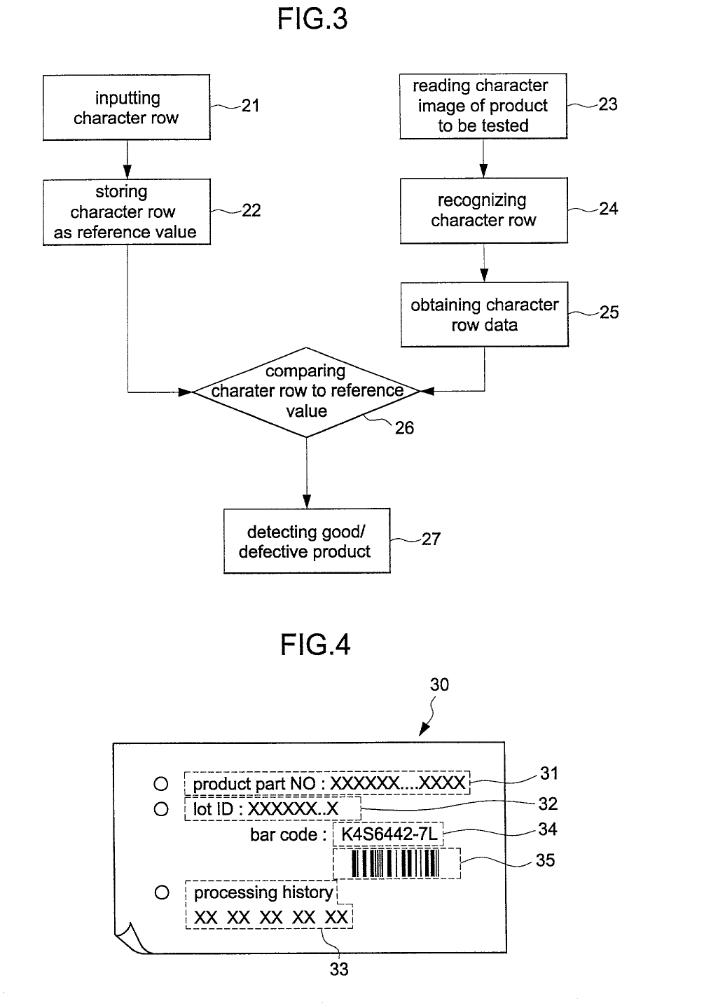

### DETAILED DESCRIPTION OF THE PREFERRED EMBODIMENTS

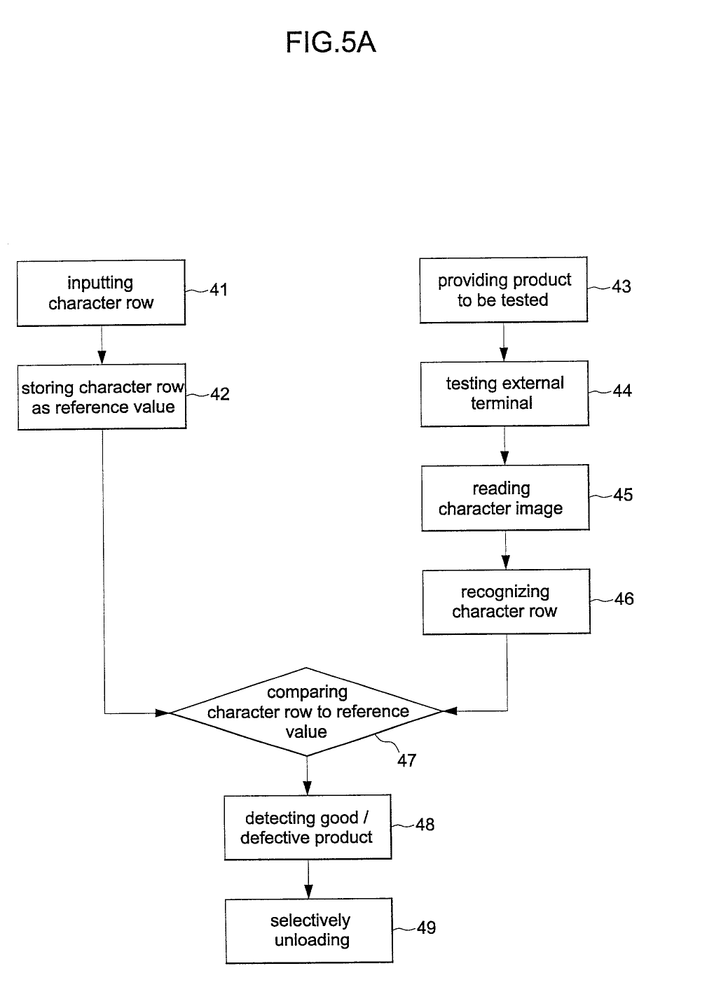

Preferred embodiments of the present invention will now be described below with reference to the accompanying drawings. Referring first to FIG. 3, a method of detecting defective markings on semiconductor products according to a first embodiment of the present invention proceeds as follows. Initially, to obtain a reference character set, a character row (including marking letters, numbers, and/or symbols) is inputted into the system using an input unit (step 21). The reference character set, corresponding to proper markings on a semiconductor product to be tested, is stored in a storage unit (step 22).

Each product in a lot is then tested. A readout system reads the actual character markings on a semiconductor product to be tested and extracts or derives the features of each of the characters (step 23). An Optical Character Recognition (OCR) unit uses the character features to recognize the characters of the character row (step 24) and convert it into character data (step 25). The OCR process can proceed according to any known or future developed method.

For instance, in the character recognition process, the extracted features can be compared with a set of templates or prototypes representing all possible letters and digits. This template database is preferably stored in PROMs. In the template matching process, individual image pixels may be used as features, and the classification may be performed by comparing marking character images with the templates from each character class. Each comparison results in a similarity measurement value between the readout character and the template. Structural classification methods may also be used, which utilize structural features and decision rules to classify characters. Structural features may be defined in terms of character strokes, character holes, or other attributes, such as concavities.

Once the actual markings have been classified as characters in a character set, that information is stored as character data. An arithmetic unit then compares the character data with the stored reference character set (step 26) by sequentially comparing the individual characters thereof, to distinguish between good and defective markings (step 27). If the actual character set matches the reference character set, the markings are good. If the character sets do not match, the markings are defective.

In this embodiment, it is also possible to detect some types of defective markings during the character recognition process, without the need to compare character sets. For instance, if the OCR unit cannot classify marking features as a character, the character markings are determined to be defective, without the further need for comparison with the reference set.

It should be noted that various methods can be used to input the reference character set. The reference character set can be directly input, for instance, into the system using a keyboard or other input device. Alternatively, the reference character set (and any other desired information), can be recorded on a lot card. A lot card is conventionally used to show the processing history of a product in a semiconductor manufacturing process. The lot card can include a bar code that includes embedded information such as the reference character set. The bar code can be scanned by a scanner to input the reference character set into the test system. Many other types of input devices could also be used.

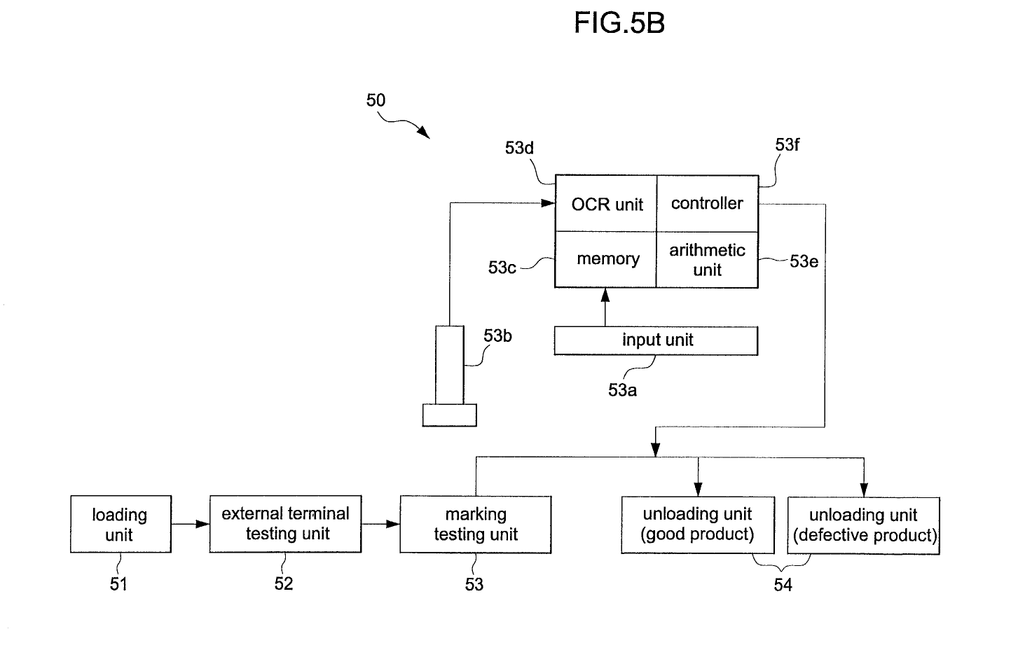

Referring to FIG. 4, a lot card 30 can include a semiconductor product part number 31, a lot ID 32, and a processing history 33, among other possible product information. A marking code, including a reference character set 34 and a bar code 35 can also be provided. Using the marking code contained on the lot card 30, an operator can input the reference character set 34 directly, using an input unit such as a keyboard, or the operator may scan the bar code 35 to input the reference character set.

In the method of detecting defective markings of FIG. 3, a readout system, such as a Charge-Coupled Device (CCD) camera or a scanner, is used to read the actual marking characters of the semiconductor products. The characters are preferably marked in a simple-styled font, to permit easy discrimination between characters by the OCR unit. Features of the character images are identified to translate the images into character data using the OCR unit. A database stores character information for each of the various possible characters in templates. The character features are compared to those templates to recognize the marking characters. Once recognized, the character marking information is stored as character data.

The method of detecting defective markings of the present invention is preferably applied at two different stages during the manufacturing process. The first stage is during a visual testing step, which follows the assembly process. The other stage is during final testing and packaging processes just prior to providing the semiconductor products to the users.

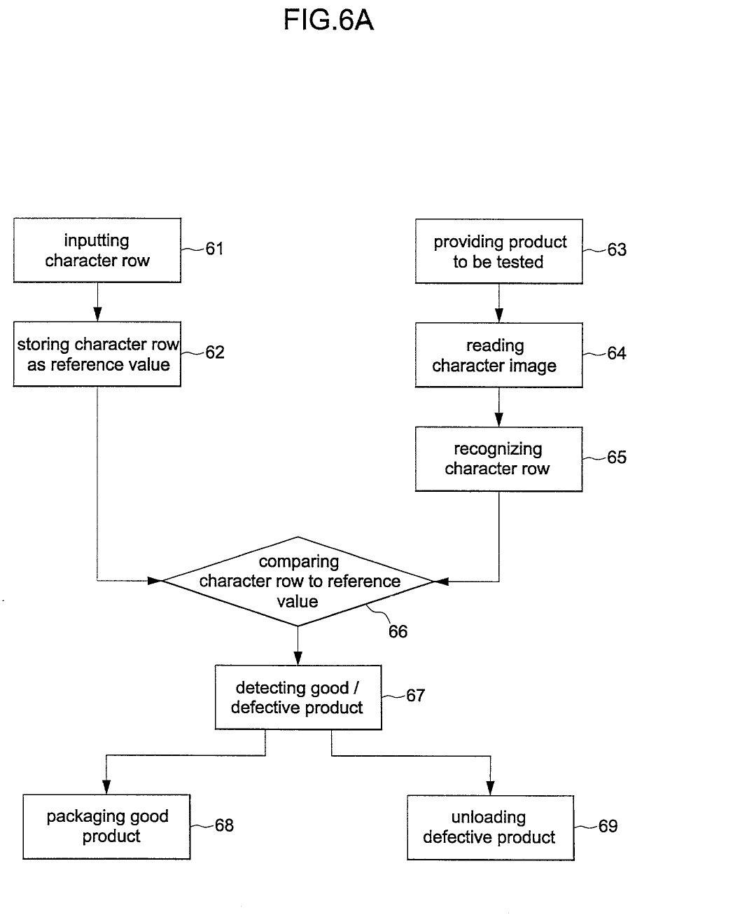

FIG. 5A is a flow chart illustrating a method of detecting defective markings on semiconductor products in accordance with another embodiment of the present invention. FIG. 5B is a schematic block diagram showing a visual testing apparatus configured to perform the method of FIG. 5A.

Referring to FIGS. 5A and 5B, a visual test apparatus 50 includes a loading unit 51 for loading the assembled semiconductor products (packages). An external terminal testing unit 52 is also included for testing external terminals of the semiconductor products. Also provided is a marking testing unit 53 for detecting defective markings on the surface of the semiconductor products. The marking testing unit 53 includes an input unit 53a, a camera 53b, a memory 53c, an OCR unit 53d, an arithmetic unit 53e, and a controller 53f. The visual test apparatus 50 may further include an unloading unit 54 for selectively unloading good products and defective products based on the test result, and a transferring means such as rails, handlers, or the like, for transferring the packages along the input unit 51, the external terminal testing unit 52, the marking testing unit 53, and the unloading unit 54.

A method of detecting defective markings according to this embodiment is as follows. In order to obtain a reference value, a character set that corresponds to proper markings of the semiconductor products is inputted using the input unit 53a (step 41). The inputted character set is stored in the memory 53c as a reference character set (step 42). The semiconductor products in a lot to be tested are then provided to the loading unit 51 (step 43), and the external terminal testing unit 52 tests the external terminals of the semiconductor product (step 44). The semiconductor products are next transferred to the marking testing unit 53. The camera 53b takes a picture of the marking characters printed on the semiconductor products to produce an image of the character row (step 45). The OCR unit 53d recognizes the characters in the image and generates character data corresponding to the actual marking characters (step 46).

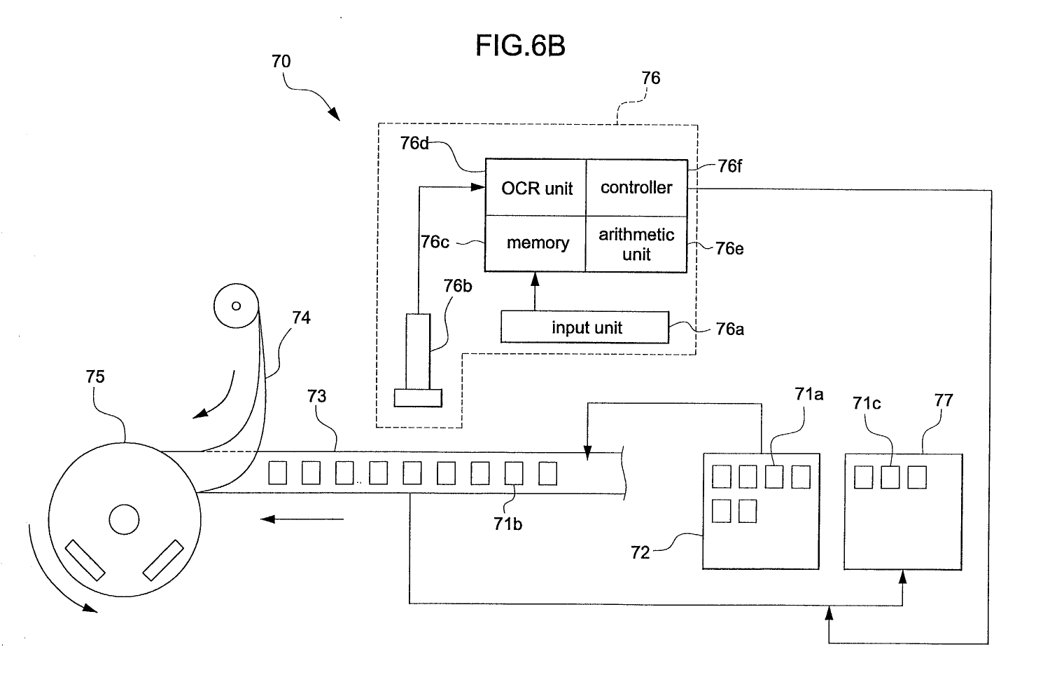

The arithmetic unit 53e then sequentially compares the obtained character data to the reference character set (step 47) to distinguish between good and defective markings (step 48). Based on the detecting results, the controller 53f selectively unloads the semiconductor products into a respective unloading unit 54 (step 49). Following the above-described visual testing step, good products are transferred to a final testing and packaging process. FIG. 6A is a flow chart illustrating a method of detecting defective marking of semiconductor products in accordance with yet another embodiment of the present invention. FIG. 6B is a schematic block diagram showing a final testing and packaging apparatus configured to apply the method of FIG. 6A.

Referring to FIGS. 6A and 6B, the final testing and packaging apparatus 70 includes a loading tray 72 that receives the semiconductor products 71a following the visual test. A carrier tape 73 carries the semiconductor products 71b. A cover tape covers the semiconductor products 71b while on the carrier tape 73. A shipping reel 75 winds the carrier tape 73, and a marking testing unit 76 detects defective markings on the semiconductor products 71b. An unloading tray 77 can also be provided to unload defective products 71c. The marking testing unit 76 preferably includes an input unit 76a, a camera 76b, a memory 76c, an OCR unit 76d, an arithmetic unit 76e, and a controller 76f. The marking testing unit 76 may also include various transferring or controlling means.

The method of detecting defective markings according to this embodiment will now be described with continued reference to FIGS. 6A and 6B. First, in order to obtain a reference character set, a character set corresponding to proper markings of a semiconductor product is input using the input unit 76a (step 61). The inputted character row is stored in the memory 76c as a reference value (step 62). The loading tray 72, including the semiconductor products 71a to be tested, is supplied to the final testing and packaging apparatus 70 (step 63). The semiconductor products 71a are transferred onto the carrier tape 73, and the camera 76b then takes a picture of character markings printed on each of the semiconductor products 71b (step 64). Each picture comprises an image of a character set corresponding to the actual markings on the product 71b.

The OCR unit 76d then recognizes the image as a character set and stores that information as the character data (step 65). The arithmetic unit 67e compares the obtained character data to the reference character set (step 66) to distinguish between good and defective markings (step 67). Based on the detecting results, the controller 76f causes the good products in the carrier tape 73 to be packaged (step 68) and the defective products to be unloaded into the unloading tray 77 (step 69).

According to the various embodiments of the present invention, a reference character set corresponding to proper markings on the semiconductor products to be tested is input into the system. Actual marking characters on the semiconductor product are then read and recognized as a character set to be compared with the reference character set. The detecting results obtained according to the various aspects of this invention are therefore more exact than those of the prior art. The rate of detecting defective markings is also improved. Moreover, different types of products in a lot are more easily distinguished from each other by comparing their marking characters. The various embodiments of the present invention therefore also improve the reliability of the products.

Although preferred embodiments of the present invention have been described above in detail, numerous variations of and modifications to the concepts disclosed herein will be apparent to those skilled in the art. All such variations and modifications are within the spirit and scope of the present invention, as defined in the appended claims.

What is claimed is:

1. A method of detecting defective markings on a semiconductor product, said method comprising:
inputting a reference character set corresponding to a semiconductor product to be tested;
extracting one or more features of actual character markings from the semiconductor product;
recognizing the actual character markings as characters using one or more of the extracted features to produce character data; and
comparing the character data to the reference character set.

2. A method according to claim 1, further comprising determining inadequate marking based on a result of comparing the character data to the reference character set.

3. A method according to claim 1, wherein inputting a reference character set comprises directly inputting the reference character set.

4. A method according to claim 3, wherein directly inputting the reference character set comprises using a keyboard to directly input characters corresponding to the reference character set.

5. A method according to claim 1, wherein inputting the reference character set comprises scanning a bar code, said bar code having information, including the reference character set, embedded therein.

6. A method according to claim 1, wherein the reference character set is recorded on a lot card.

7. A method according to claim 1, further comprising reading actual character markings of the product comprises using a Charge-Coupled Device (CCD) camera or a scanner to obtain an image of the character markings.

8. A method according to claim 1, wherein recognizing the actual character markings as characters comprises using an Optical Character Recognition (OCR) technique.

9. A method of detecting defective character markings on a semiconductor product following assembly thereof, said method comprising:
inputting and storing a reference character set corresponding to the semiconductor product;
testing external terminals of said semiconductor product;
reading actual marking characters of the product as a character image;
recognizing the character image as characters to produce character data;
comparing the character data to said reference character set to detect defective product markings; and
selectively unloading good products and defective products based on the detecting result.

10. A method according to claim 9, wherein converting the character image into character data is performed using an Optical Character Recognition (OCR) technique.

11. A method according to claim 9, wherein the semiconductor products are provided to a testing unit in a lot.

12. A method according to claim 9, wherein the reference character set is recorded on a lot card.

13. A method according to claim 12, wherein the reference character set from the lot card is directly input using a keyboard.

14. A method according to claim 12, wherein the reference character set is recorded in a bar code and wherein the reference character set is input by scanning the bar code.

15. A method of detecting defective markings on a semiconductor product that has already been assembled and subjected to a visual test, said method comprising:
inputting a reference character set that represents proper character markings of the semiconductor product;
storing the reference character set in memory;
providing the semiconductor product to a testing unit in a loading tray;
transferring the product onto a carrier tape; reading actual character markings of the product as a character image;
converting the character image into character data by recognizing the character image as a set of characters using an Optical Character Recognition (OCR) technique;
comparing the character data to said reference character set to detect defective product markings; and
unloading products with defective markings onto an unloading tray.

16. A method according to claim 15, wherein the reference character set is inputted by scanning a bar code on a lot card.

17. A method according to claim 15, wherein the reference character set is input using a keyboard.

18. An apparatus for detecting defective markings on a semiconductor product, said apparatus comprising:
an input unit for inputting a reference character set corresponding to a semiconductor product to be tested;
a memory unit configured to store the reference character set;
a readout system configured to read actual markings of the product to be tested as a character image;
an Optical Character Recognition (OCR) unit configured to recognize the character image as an actual character set; and
an arithmetic unit configured to compare the actual character set to the reference character set.

19. An apparatus according to claim 18, wherein the input unit comprises a keyboard configured to permit a user to directly input the character row into the apparatus.

20. An apparatus according to claim 18, wherein the input unit comprises a scanner configured to input the character row by scanning a bar code.

21. An apparatus according to claim 18, wherein the readout system comprises a Charge-Coupled Device (CCD) camera or a scanner.

22. An apparatus according to claim 18, further comprising an unloading unit and a controller, wherein the controller is configured to control unloading of good and defective products from the unloading unit.

23. An apparatus according to claim 18, further comprising an external terminal testing unit configured to test external terminals of the semiconductor product.

24. An apparatus according to claim 18, further comprising a loading tray and a carrier tape, wherein the apparatus is configured to transfer the product to be tested from the loading tray to the carrier tape before the character image is obtained by the readout system.

25. A method of detecting defective markings on a semiconductor product, said method comprising:
extracting one or more features of actual character markings from the semiconductor product; and
recognizing the actual character markings as characters using one or more of the extracted features.

26. A method according to claim 25, further comprising classifying the product as defective if one or more of the actual character markings cannot be recognized as a character.
